(19) United States
(12) Patent Application Publication
(10) Pub. No.: US 2015/0113643 A1
(43) Pub. Date: Apr. 23, 2015

(54) INFORMATION SECURITY METHOD

(71) Applicant: NATIONAL TSING HUA UNIVERSITY, HSINCHU (TW)

(72) Inventors: SHIH YU CHANG, HSINCHU CITY (TW); TIN WEI LIN, TAINAN CITY (TW)

(73) Assignee: NATIONAL TSING HUA UNIVERSITY, HSINCHU (TW)

(21) Appl. No.: 14/056,791

(22) Filed: Oct. 17, 2013

(51) Int. Cl. H04L 29/06

(52) U.S. Cl. CPC H04L 63/1408; H04L 63/08
USPC 726/23; 713/168

(57) ABSTRACT

A method for information security comprises determining by a first processor whether web content includes malicious software by matching the web content with at least one recorded threat, determining by the first processor whether the quantity of malicious software reaches a threshold, processing by a second processor the malicious software with a cryptographic protocol to generate a processing result, if the quantity of malicious software reaches the threshold, and generating a message indicating a threat in response to the processing result.

### TECHNICAL FIELD

The present disclosure is generally related to information security and, in particular, to a method and a device for enhancing protection against a potential threat.

### BACKGROUND

In current approaches for information security over the Internet, the Secure Sockets Layer (SSL) protocol is used by a central processing unit (CPU) of an electronic device to identify malicious malware carried by various web contents. However, with the rapid development of electronic transactions, the SSL protocol is more frequently utilized by a CPU and thus consumes considerable amounts of resources of the CPU in a large number of encryption and decryption operations, for example, generating RSA asymmetric handshake cryptographic functions.

Consequently, the CPU may not handle malicious software in time or may significantly slow down in processing, which results in undesirable performance of the CPU.

### SUMMARY

In accordance with an embodiment of the present disclosure, a method for information security comprises determining by a first processor whether web content includes malicious software by matching the web content with at least one recorded threat, determining by the first processor whether the quantity of malicious software reaches a threshold, processing by a second processor the malicious software with a cryptographic protocol to generate a processing result, if the quantity of malicious software reaches the threshold, and generating a message indicating a threat in response to the processing result.

In accordance with another embodiment of the present disclosure, an electronic device comprises a display for displaying web content, a first processor configured to determine whether the web content includes malicious software by matching the web content with at least one recorded threat, and to determine whether the quantity of malicious software reaches a threshold, a second processor configured to process the malicious software if the quantity of malicious software reaches a threshold, and a network security accelerator, coupled to the second processor, configured to process the malicious software with a cryptographic protocol to generate a message indicating a threat.

In accordance with still another embodiment of the present disclosure, a method for information security comprises receiving an electronic valid certificate from the Internet by a first processor, processing a cryptographic protocol by a second processor, and examining the authentication of the electronic valid certificate by a network security accelerator, using the processed cryptographic protocol, to generate an examining result.

### BRIEF DESCRIPTION OF THE DRAWINGS

The details of one or more embodiments of the disclosure are set forth in the accompanying drawings and the description below. Other features and advantages of the disclosure will be apparent from the description, drawings and claims.

FIG. 1 is a block diagram of an electronic device in accordance with some embodiments.

FIG. 2 is a flow diagram of a method for information security in accordance with some embodiments.

FIG. 3 is a flow diagram of a method for information security in accordance with some embodiments.

Like reference symbols in the various drawings indicate like elements.

### DETAIL DESCRIPTION

Embodiments, or examples, of the disclosure illustrated in the drawings are now described using specific languages. It will nevertheless be understood that no limitation of the scope of the disclosure is thereby intended. Any alterations and modifications in the described embodiments, and any further applications of principles described in this document are contemplated as would normally occur to one of ordinary skill in the art to which the disclosure relates. Reference numbers may be repeated throughout the embodiments, but this does not necessarily require that feature(s) of one embodiment apply to another embodiment, even if they share the same reference number. It will be understood that when an element is referred to as being “connected to” or “coupled with” another element, it may be directly connected to or coupled to the other element, or intervening elements may be present.

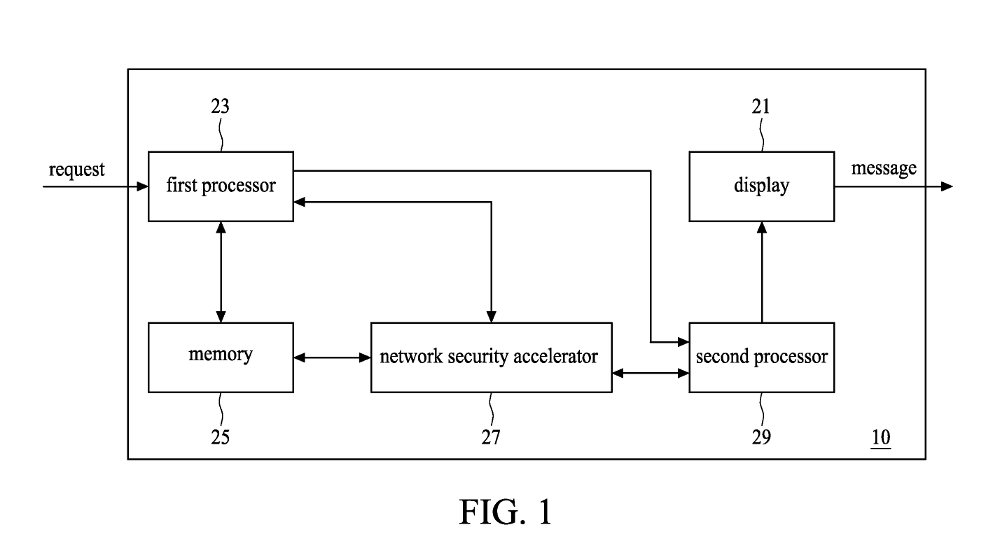

FIG. 1 is a diagram of an electronic device 10 in accordance with some embodiments. The electronic device 10 includes but is not limited to a cell phone, laptop computer, personal computer, smart television, and personal digital assistant (PDA). As shown in FIG. 1, the electronic device 10 comprises a display 21 for displaying web content, a first processor 23, a memory 25 storing at least one program, a second processor 29 , and a network security accelerator 27 coupled to the second processor 29.

The first processor 23 includes, for example, a central processing unit (CPU), which is configured to execute the at least one program. The second processor 29 includes, for example, a graphics processing unit (GPU), which is configured to process computer graphics. With its advanced computing capability and highly parallel structure, a GPU is more effective than a general-purpose CPU for algorithms where is processing of large blocks of data is done in parallel.

The at least one program comprises at least one instruction for receiving a request for a malicious software check for web content. The request is made by a user who clicks a link address, for example, a potential malicious software link address carried in an e-mail displayed by a web content displaying interface, such as a web browser. In some embodiments, the at least one program comprises at least one instruction for determining whether web content includes malicious software by matching the web content with at least one recorded threat. Moreover, in some embodiments, the at least one program comprises at least one instruction for determining whether the quantity of malicious software reaches a threshold. Furthermore, the at least one program comprises at least one instruction for triggering the network security accelerator 27 to process the malicious software in accordance with a cryptographic protocol. The cryptographic protocol includes, for example, the secure sockets layer (SSL). In addition, the at least one instruction triggers the second processor 29 to generate a processing result, if the quantity of malicious software reaches the threshold. Furthermore, the at least one program comprises at least one instruction for generating a message indicating a threat in response to the processing result. The message is displayed on a web content displaying interface by the display 21 via the second processor 29 to inform the user.

In still some embodiments, the at least one program further comprises at least one instruction for processing the malicious software by the first processor 23 in accordance with a cryptographic protocol if the quantity of malicious software is less than the threshold. Moreover, the at least one program further comprises at least one instruction for generating a message indicating a threat in response to the processing result. The message is displayed on a web content displaying interface by the display 21 via the second processor 29 to inform the user.

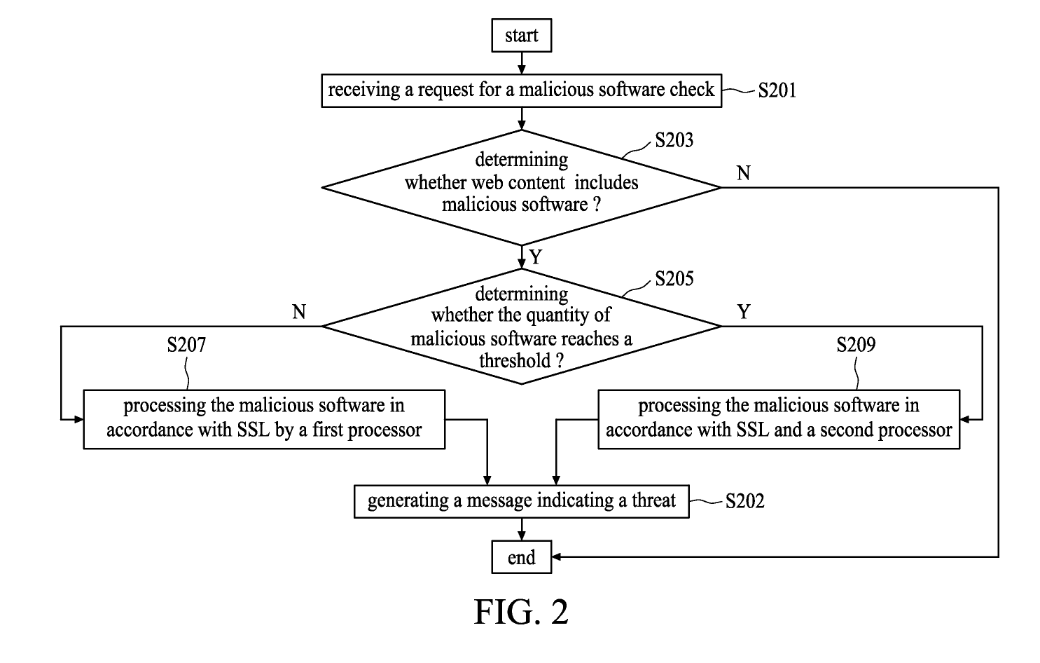

FIG. 2 is a flow diagram of a method for information security in accordance with some embodiments.

Referring to FIG. 2, in step S201, a request to perform a malicious software check for the web content is received by a first processor, for example, a user clicks a link address such as a potential malicious software address carried in an e-mail displayed by a web content displaying interface, to retrieve web content. The first processor includes a CPU.

In step S203, the first processor determines whether the web content includes malicious software by matching the web content with at least one recorded threat. If the web content matches a recorded threat, step S205 is performed. If the web content does not match any recorded threat, the method is finished.

Next, in step S205, the first processor determines whether the quantity of malicious software reaches a threshold. In some embodiments, the threshold is set to, for example, 2000 pieces of malicious software.

If the quantity of malicious software reaches the threshold, the first processor generates a signal to trigger a network security accelerator and step S209 is performed. In step S209, the network security accelerator processes the malicious software in accordance with a cryptographic protocol and generate, in conjunction with a second processor, a processing result. In response to the processing result, a message indicating a threat is generated and displayed on the web content displaying interface in step S202. The second processor includes, for example, a GPU. The cryptographic protocol includes, for example, an SSL.

If the quantity of malicious software does not reaches the threshold, step S207 is performed. In step S207, the malicious software is processed by the first processor in accordance with the cryptographic protocol to generate a processing result. In response to the processing result, a message indicating a threat is generated and displayed on the web content displaying interface in step S202.

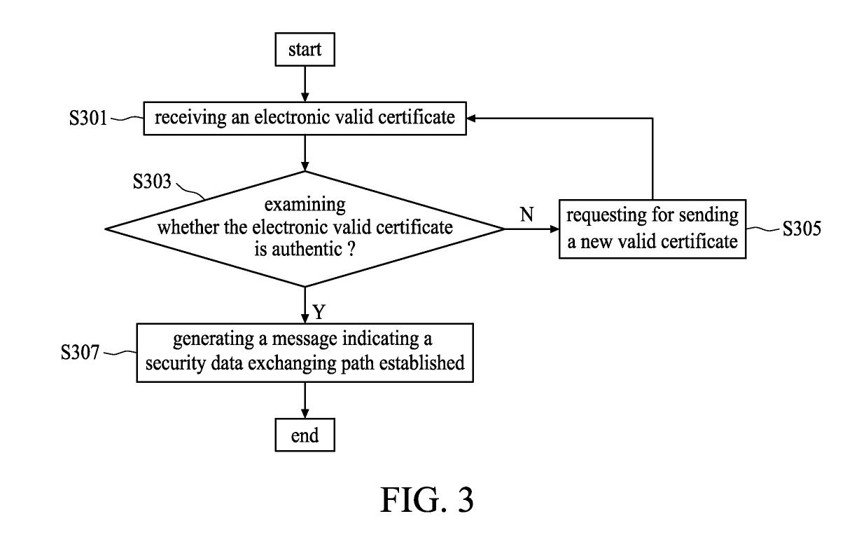

FIG. 3 is a flow diagram of a method for information security in accordance with some embodiments.

As shown in FIG. 3, in step S301, an electronic valid certificate, for verifying a user's identification sent from a bank's website, is received by a first processor, for example, a CPU. A user's identification is sent when the user is retrieving web content, for example, the user's financial information, from the bank's website by a web browser. Since the electronic valid certificate is transmitted via the Internet, intruders might intercept and tamper with the electronic valid certificate and then forward a tainted electronic valid certificate to the user.

In step S303, a cryptographic protocol, for example, an SSL, is processes by a second processor, such as a GPU. A network security accelerator is triggered by a signal coming from the first processor to examine the authentication of the electronic valid certificate in accordance with the processed cryptographic protocol, and generate an examining result.

In step S305, when the examining result indicates that the electronic valid certificate is tainted, at least one instruction, executed by the first processor, requests the bank's website to send a new electronic valid certificate for examination, which is performed in step S303, and discards the tainted electronic valid certificate.

Next, in step S307, when the examining result indicates that the electronic valid certificate is not tainted, a message indicating a security data exchanging path established is generated and displayed by the web browser. Moreover, the security data exchanging path is for exchanging the user's financial information.

A number of embodiments of the disclosure have been described. It will nevertheless be understood that various modifications may be made without departing from the spirit and scope of the disclosure. Embodiments of the disclosure are applicable in various design choices.

The above description includes exemplary operations, but these operations are not necessarily required to be performed in the order shown. Operations may be added, replaced, changed order, and/or eliminated as appropriate, in accordance with the spirit and scope of the disclosure. Accordingly, the scope of the disclosure should be determined with reference to the following claims, along with the full scope of equivalences to which such claims are entitled.

What is claimed is:

1. A method for information security, the method comprising:
determining, by a first processor, whether web content includes malicious software by matching the web content with at least one recorded threat;
determining, by the first processor, whether the quantity of malicious software reaches a threshold;
processing, by a second processor, the malicious software with a cryptographic protocol to generate a processing result, if the quantity of malicious software reaches the threshold; and
generating a message indicating a threat in response to the processing result.

2. The method of claim 1, further comprising displaying the message on a web content displaying interface.

3. The method of claim 1, further comprising receiving a request for a malicious software check for the web content before determining the web content.

4. The method of claim 1, wherein the cryptographic protocol includes a Secure Sockets Layer (SSL) protocol.

5. The method of claim 1, further comprising processing by the first processor the malicious software with the cryptographic protocol if the quantity of malicious software is less than the threshold.

6. The method of claim 1, wherein the first processor includes a central processing unit (CPU), and the second processor includes a graphics processing unit (GPU).

7. An electronic device, comprising:
a display for displaying web content;
a first processor configured to determine whether web content includes malicious software by matching the web content with at least one recorded threat, and to determine whether the quantity of malicious software reaches a threshold;
a second processor configured to process the malicious software if the quantity of malicious software reaches a threshold; and
a network security accelerator, coupled to the second processor, configured to process the malicious software with a cryptographic protocol to generate a message indicating a threat.

8. The electronic device of claim 7, wherein the first processor is configured to receive a request for a malicious software check for the web content.

9. The electronic device of claim 7, wherein the first processor includes a central processing unit (CPU), and the second processor includes a graphics processing unit (GPU).

10. The electronic device of claim 7, wherein the cryptographic protocol includes a Secure Sockets Layer (SSL) protocol.

11. The electronic device of claim 7, wherein the first processor is configured to process the malicious software in accordance with the cryptographic protocol to generate a processing result, if the quantity of malicious software is less than the threshold.

12. The electronic device of claim 11, wherein the network security accelerator is configured to generate the message in response to the processing result.

13. The electronic device of claim 7, further comprising a web content displaying interface to display the message.

14. A method for information security, the method comprising:
receiving an electronic valid certificate from the Internet by a first processor;
processing a cryptographic protocol by a second processor; and
examining the authentication of the electronic valid certificate by a network security accelerator, using the processed cryptographic protocol, to generate an examining result.

15. The method of claim 14, wherein the cryptographic protocol includes a Secure Sockets Layer (SSL) protocol.

16. The method of claim 14, further comprising generating a message indicating a security data exchanging path.

17. The method of claim 16, further comprising displaying the image on a web content displaying interface.

18. The method of claim 14, wherein the first processor includes a central processing unit (CPU), and the second processor includes a graphics processing unit (GPU).

19. The method of claim 14, further comprising requesting for sending a new electronic valid certificate for examination and discarding a tainted electronic valid certificate, if the examining result indicates that the electronic valid certificate is tainted.

20. The method of claim 14, further comprising generating a message by the first processor, and displaying the message on a web content displaying interface, if the examining result indicates that the electronic valid certificate is not tainted.
